(19) United States
(12) Patent Application Publication
(10) Pub. No.: US 2015/0119480 A1
(43) Pub. Date: Apr. 30, 2015

(54) Use of Gas Adsorbed to Moledular Sieves to Expand One-Component Foams upon Exposure to Moisture

(71) Applicant: Royal Adhesives & Sealants Canada Ltd., Toronto (CA)

(72) Inventors: Alexander Botrie, Toronto (CA); Yuan Deng, Scarborough (CA); Scott Cowen, Guelpho (CA)

(73) Assignee: Royal Adhesives & Sealants Canada Ltd., Toronto (CA)

(21) Appl. No.: 14/064,254

(22) Filed: Oct. 28, 2013

(51) Int. Cl. C08J 9/12

(52) U.S. Cl. CPC C08J 9/12
USPC 521/91

(57) ABSTRACT

A one-component moisture curing composition expands and cures under ambient conditions without the use of external blowing agents. The one-component moisture cure foam contains (1) a moisture curing polymer, (2) anhydrous molecular sieves that are able to adsorb atmospheric moisture to release adsorbed gases, optionally (3) catalyst compound(s) to accelerate the reaction between atmospheric moisture and the polymer, and optionally (4) other additives such as surfactants, fillers, adhesion promoters, pigments, water scavengers and foamable additives.

### FIELD OF THE INVENTION

The invention relates to one-component moisture-curable polymers containing molecular sieves, preloaded with gases. Upon exposure to atmospheric humidity, the moisture curable groups of the polymers crosslink to cure the polymer, while simultaneously the adsorbed gases desorb from the molecular sieve to foam the polymers.

### BACKGROUND

Moisture curable polymers, including silylated polyurethane polymer, alkoxysilane terminated polyether polymers, moisture cure silicone polymers, and polyurethane polymers, react with atmospheric moisture to cross-link and gel. They are widely used in adhesives, sealants, and coatings and are typically packaged as ready for use products.

Adhesives, sealants, and coatings can be formulated to have a wide range in rheological and physical properties through blending moisture curable polymers with additives. Some of the properties that can be controlled include viscosity, density, gel time, adhesion, tensile strength, and elongation. However, it is desirable to foam these polymers to further increase their usefulness. The benefits of such foam include increased sound dampening, greater gap and cavity filling, increased shock and vibration suppressing, higher degree of insulation, reduced weight, increasing hollow structure strength, and lower material usage for a given application area.

Two component foams are widely available for a variety of polymers including polyurethanes and silicones. These foams are packaged as two separate components that are mixed just prior to use to initiate cross-linking and expansion. In the case of polyurethanes, one component contains isocyanate and the second component contains an active hydrogen molecule and a blowing agent, such as water. When mixed, the water reacts with the isocyanate to generate CO₂ gas and expand the foam, while the reaction between isocyanate and the active hydrogen group of the second component results in cross-linking and curing of the foam.

Room temperature vulcanizing (RTV) silicone foams, as known in the art, have been commercially available for decades. They can be formulated as low density liquid products that foam and cure readily at room temperature. They can be utilized in foam-in-place applications. For example, U.S. Pat. No. 4,767,794 employs a two component system where component one is a mixture of vinyl-containing polysiloxanes, a hydroxyl source, a platinum catalyst, and an amine compound (to decrease foam density). The second component consists of a hydride polysiloxane. Just prior to use, the two components are mixed at a designed ratio, whereupon a cross-linking (curing) reaction takes place simultaneously with the liberation of a hydrogen gas. In general, the expansion and curing of two component foams occur primarily through dehydrogenative condensation and vinyl addition reactions, respectively, such that within minutes completely cured elastomeric foam is generated at room temperature. However, because they are multiple component systems, RTV foams require exact mixing ratios, needing special dispensing systems and they suffer from a short open time, and thus are not suitable for some adhesive/sealant applications.

The vast majority of available moisture curable silicone and polyurethane one-component foams are gas injection based. In this technology, adhesive/sealant materials are mixed with an inert gas. For instance, US Pub. 2009/0159178 A1 uses N₂, to produce a homogenous mixture under a high pressure. When the material is dispensed, the gas expands creating closed-cell foam. However, these foamed materials have short working times and can be difficult to apply in a controlled manner.

Another available approach for generating one-component foam is through the addition of a chemical agent that decomposes or evaporates when the conditions are changed. For example an elevation in temperature, as used in U.S. Pat. No. 5,332,762, or the exposure to microwaves, as used in U.S. Pat. No. 4,460,713. U.S. Pub. 2011/0224317 A1 discloses the use of encapsulating agents, which are broken or melted to release acids or bases that react to produce a gas. However, there are many applications where such methods are not practical.

Molecular sieves have been disclosed for use in foams for a variety of reasons. For example, U.S. Pat. No. 6,414,045 B1 discloses a gas propelled, one-component moisture curable polyurethane foam that cures in low humidity, and U.S. Pub. 2011/0319261 A1, discloses a cellulose containing foam that rapidly adsorbs and desorbs humidity. Both patents mention molecular sieves as potential fillers, but neither disclose its use to aid in the foaming process. In U.S. Pat. No. 4,916,173, molecular sieves are added to a polyurethane syntactic foam to remove water, for the reduction of premature foaming and increase the density uniformity. While, U.S. Pat. No. 4,341,689 uses molecular sieves to transport amines for use in the curing process of an ambient pressure and temperature two-component sealant, no foaming is disclosed.

U.S. Pat. No. 4,906,672 describes methods to introduce additional CO₂ and CO₂ generating compounds in continuous casting flexible polyurethane foams. One of the methods discussed is the adsorption of propylene carbonate to molecular sieves, other salts or porous fillers. It is further disclosed that the molecular sieves not only act as transport vessels, but they also catalyze the decomposition of propylene carbonate to propylene oxide, which is then free to react with isocyanate and produce CO₂, under the reaction conditions of 90-110° F. and 75-900 psi.

U.S. Pat. No. 4,518,718 discloses a two-component polyurethane foam that utilizes molecular sieves. The polyols are loaded with up to 60% molecular sieves that are preloaded with catalyst or reactive compounds, including water, which can be released on heating the cured foam to complete cross-linking and produce a harder foam. However, the application of heat after the foam is cured is not practical for many applications.

Several patents discuss the use of molecular sieves in two-component foams. For instance, W.O. Pat. 90/03,997 discloses the use of molecular sieves, and other additives, to release water, or dehydrate, to help produce more uniform foams and allow for a shorter cool down period. Likewise, G.B. Pat. 1,285,224 discloses the use of molecular sieves to transport hydrated molecules that dehydrate to release water, such that it can react with isocyanate and produce a second blowing source in addition to the primary blowing agent. U.S. Pat. No. 5,847,017 discloses the use of molecular sieves, loaded with carrier gases, to expand foaming material once a pre-selected temperature and pressure is reached.

In U.S. Pat. No. 4,822,363, wet and activated molecular sieves, containing up to 2% water based on the weight of the completely anhydrous molecular sieve, are used to transport water or carbon dioxide that act as blowing agents. Carbon dioxide may be used to air-charge the polyol before molecular sieves are added, or may be added to the molecular sieves before they are added to the polyol. The polyol component, containing polyol, water/carbon dioxide, catalyst and molecular sieves, is mixed with the isocyanate immediately before being poured into the mold that has been heated to greater than >30° C.

The use of molecular sieves in non-curing aerosol foams has also been described. In U.S. Pat. No. 4,574,052, molecular sieves are added to absorb some of the liquid propellant, such that the pressurized foam will continue to bubble after reaching atmospheric pressure. While this method utilizes atmospheric moisture adsorbing to the molecular sieves to force trapped gas out of the sieve, it is the reduction in pressure that causes the expansion of this foam.

Molecular sieves have not been used to generate foamed one-component polymers under ambient conditions. It is therefore desired to utilize the release of gas adsorbates, from molecular sieves, to expand moisture curable polymers under ambient temperature and pressure. The molecular sieves that can be used for this process are those that have preferential affinity to an atmospheric gas, typically water, over the chosen adsorbate, such that upon exposure to atmospheric gases, displacement of the adsorbate causes expansion of the moisture curable polymers. The ideal foam will retain the basic properties of a one-component adhesive/sealant, including environmental friendliness (little to no solvent or VOCs), good adhesion to various substrates, acceptable curing rates (open time, skin time), in addition to being able to generate gas to expand the foam. The foam should have a controlled foam density, exhibit controllable volume expansion to allow better gap filling, show a higher degree of sound deadening and insulation properties, while lowering material usage and reducing cost. Hitherto no such one-component moisture curable foam composition has been described that is curable and foams, with the presence of atmospheric moisture.

### SUMMARY OF THE INVENTION

In accordance with aspects of the present invention, a one-component moisture curable foam composition comprises (1) a moisture curable polymer, (2) anhydrous molecular sieves, optionally (3) one or more catalysts, and optionally (4) other additives. The foam composition has excellent moisture curing and moisture foaming properties while exhibiting excellent storage stability.

In accordance with certain aspects, polymers may be silylated polyurethanes, alkoxysilane terminated polyethers, moisture cure silicones, and polyurethanes.

In accordance with aspects of the invention, molecular sieves may include synthetic or naturally occurring molecular sieves. Due to the strong affinity molecular sieves have for water, any molecule on their surface or in their pores will desorb to allow water to adsorb.

In accordance with aspects of the invention, a catalyst compound can be used to promote the reaction between atmospheric water and the moisture curing functional group of the polymer.

In accordance with other aspects, additives such as such as fillers, plasticizers, solvents, surfactants, adhesion promoters, pigments water scavengers, foamable additives are added to allow for further modification of the degree of foaming, in addition to other wet and cured properties including viscosity, thixotropic index, hardness, tensile strength and elongation.

### BRIEF DESCRIPTION OF THE DRAWINGS

FIG. 1 displays the relationship between the cured foam density and the molecular sieve concentration.

### DETAILED DESCRIPTION

The present invention is directed to a one-component moisture curing foam synthesized from a composition comprising (1) a moisture-curable polymer, (2) anhydrous molecular sieves, optionally (3) one or more catalyst compounds, and optionally (4) other additives.

Although not wishing to be bound to any particular theory, it is believed that upon exposure to moisture, the polymer cross-links to build viscosity and cure, simultaneously water molecules are adsorbed onto the surface and pores of the molecular sieve forcing the desorption of other gaseous adsorbates leading to the expansion of the polymer.

In accordance with certain aspects, polymers may be silylated polyurethanes, alkoxysilane terminated polyether polymers, moisture cure silicones, and polyurethanes Silylated polyurethanes are polymers based on polyurethanes terminated with silane moisture curing groups; known to persons skilled in the art under the designation as “SPUR” (Silyl Terminated Polyurethanes). Alkoxysilane terminated polyether polymers are known to persons skilled in the art under the designation “MS polymers.” Moisture curable silicones contain polysiloxane polymers containing hydrolyzable substituent groups, and silicon cross-linking agents containing two or more hydrolyzable substituent groups, as known to those skilled in the art. Other polymers containing 2 or more silylated groups are also useful. And polyurethanes, of the present invention, are isocyanate terminated prepolymer adducts of excess isocyanate combined with polyols

The moisture-curable polymer is present in an amount from 5 to 95% by weight, preferably 10 to 70% by weight based on total weight of the composition. The amount of pretreated molecular sieve that is added is dependant on the desired foam density and may be limited by the increase in viscosity that is associated with the addition of a powder. Molecular sieves may be added at levels of 3 to 75% by weight, preferably 5 to 50% by weight, based on total weight of the composition. Cumulative catalysts amounts that can be used in the practice of the present invention, may be up to 10% by weight, but are preferably less than 3% by weight based on total weight of the composition. Other additives may be loaded up to about 90% by weight of the total composition, but are preferably less than 75% by weight.

### Silicone

In one embodiment moisture-curable silicones are employed. Typically, these consist of a mixture of polysiloxane polymers containing hydrolyzable substituent groups and silicon cross-linking agents containing two or more hydrolyzable substituent groups. Suitable polysiloxane polymers consist of one or more silicone polymer/copolymer of the formula R₃Si-(A)ₓ-(B)_{y}—OSiR₃ where A and B are —OSiR₂— groups, x and y are numbers selected to provide a polymer that exhibits the desired viscosity, and each R is independently hydroxyl, a hydrolyzable organic group or a hydrocarbon, given that at least one R per molecule is hydroxyl or at least two R per molecule are hydrolyzable organic groups. Hydrolyzable organic groups, suitable for use in the invention, are those that are capable of hydrolyzing in the presence of moisture, including alkoxy, oximo, acetoxy, amino, aminoxy, or acyloxy groups. Hydrocarbons groups, suitable for the invention, include acyclic hydrocarbons, alicyclic hydrocarbons, or aromatic hydrocarbons. Where alicyclic hydrocarbons may be branched or straight chained, may be saturated or unsaturated, may contain one or more halogen atom, and preferably contains 1 to 20 carbons per chain. Acyclic hydrocarbons have one or more saturated hydrocarbon rings, preferably containing 6 to 10 carbons per ring, which may be substituted with one or more alkyl groups, and in the case of multiple rings, may be fused. Aromatic hydrocarbons have one or more aromatic hydrocarbon rings, which may be substituted with one or more alkyl groups. Any polysiloxane polymer may be used such that it exhibits a viscosity between 50 and 500,000 cps as measured by a Brookfield Viscometer.

Silicone cross-linking agents typically have the formula RₙSiZ₄₋ₙ, where R is a monovalent hydrocarbon, Z is a hetero-alkyl or hetero-aryl group—capable of hydrolyzing in the presence of moisture; and n is 0, 1, or 2. Suitable hetero-alkyl or hetero-aryl groups may be dialkylketoximo, alkoxy, acyloxy, oximo, aminoxy, alkamino or arylamino groups. Corresponding di-, tri- and polysiloxanes organo hydrogen polysiloxanes are also suitable for use in the invention. Examples include vinyltrimethoxysilane, tetramethoxysilane, ethyltriacetoxysilane, tetraethoxysilane, methyltrimethoxysilane, di-t-butoxydiacetoxysilane, methylphenyldiethoxysilane, 3,3,3-trifluoropropyltrimethoxysilane, methyltri(methylethylketoximo)silane, ethyltri(N,N-diethylamino)silane, methyltriacetoxysilane, methyltri(N-methylacetamido)silane, n-propylorthosilicate, and ethylpolysilicate.

### Alkoxysilane Terminated Polyethers

Alkoxysilane terminated polyether polymers are commonly referred to as MS polymers. Suitable MS polymers are sold under the tradename Kaneka MS and are disclosed in U.S. Pat. No. 3,971,751. The most suitable of the available MS polymers are 5203H, 5303H S227 and SAX400, all sold by Kaneka.

### Polyurethane

In another embodiment, isocyanate terminated polyurethane prepolymers are used. The ratio of equivalents of isocyanate to polyol ranges from about 1.2:1 to about 30:1, preferably from about 1.5:1 to about 10:1. Up to about 2% by weight of a catalyst can be used based on the total weight of the composition, preferably the catalyst should range from 0.01 to about 0.4% by weight, based on total weight of the composition. Organotin catalysts are generally preferred, however, other catalysts, including organic metallic catalysts, such as organic bismuth and organic zinc, may be used.

Isocyanates particularly useful in the preparation of the polyurethane prepolymers are aromatic and aliphatic diisocyanates. The selection of the diisocyanate influences the viscosity of the prepolymer and determines the physical properties of the polymer, as is known to those skilled in the art. Representative examples of useful diisocyanates include, but are not limited to, toluene diisocyanate (TDI), methane diphenylisocyanate (MDI), isophorone diisocyanate (IPDI), hexamethylenediisocyanate (HDI), hydrogenated methane diphenylisocyanate (H-MDI), tetramethylxylene diisocyanate (TMXDI), cyclohexane diisocyanate, noraboradiene diisocyanate (NDI), polymethylene phenylene isocyanate, allophanates of any of the foregoing, biurets of any of the foregoing, and trimers of any of the foregoing of the above listed diisocyanates may be used.

Polyols useful in the preparation of the polyurethane polymers can be either one or a combination of polyether, polyester, or polyalkyldiene polyols, or derived from reaction of excess of such polyols, alone or in combination with isocyanate function compounds. The polyols can be diols or triols, preferably, polyether diols are used. Representative examples of useful polyols include polyoxypropylene polyol, polyalkylene polyol, and polypropylene glycols. Preferably, polyether diols having high equivalent weights are used. For example, polyether diols with equivalent weights ranging from greater than about 200 to about 20000 may be used, with 500 to about 5000 being preferred.

### Silylated Polyurethane

In one embodiment, silylated polyurethane polymers are an adduct of at least one moisture sensitive silane endcap agent and at least one polyurethane prepolymer. Those useful in aspects of the present invention contain hydrolysable silane groups.

The polyurethane prepolymer, for the silylated polyurethane, can be an isocyanate terminated or a hydroxyl terminated polyurethane. Isocyanate terminated polyurethane prepolymer is an adduct of at least one polyol, at least one diisocyanate, and preferably, at least one catalyst. U.S. Pub. 2006/0251902 teaches a formula and method for making polyurethane prepolymers suitable for the invention, and is hereby incorporated by reference. The ratio of equivalents of isocyanate to polyol ranges from about 1.1:1 to about 8:1, preferably from about 1.4:1 to about 4:1. Up to about 2% by weight of a catalyst can be used based on the total weight of the composition, preferably the catalyst should range from 0.01 to about 0.4% by weight. Organotin catalysts are generally preferred, however, other catalysts, including organic metallic catalysts, such as organic bismuth and organic zinc, may be used.

The moisture sensitive hydrolysable silane endcap precursors in the present invention have a chemical structure of (Y)—R—SiRₙ—(X)₃₋ₙ. X is the hydrolysable functional group such as, but not limited to OH, OR, N(R), enoxy, acyloxy, oximo, aminoxy, and amido. R is any linear or branched alkyl group containing at least 1 carbon atom, preferably 1 to 4 carbon atoms, such as —CH₃, —CH₂CH₃, and —CH₂CH₂CH₃. Y is any hydrogen residue functional group that is reactive with the isocyanate group of the polymer such as H₂N—, RNH—, and HS—. The ratio of equivalents of the end group of prepolymer to the endcap precursor is approximately 1:0.5 to 1:2, preferably from about 1:1.02 to about 1:1.05.

Preferred hydrogen active organofunctional silanes include amino-alkoxysilanes and mercapto-alkoxysilanes. Examples of other suitable silanes include, but are not limited to, phenyl amino propyl trimethoxy silane, methyl amino propyl trimethoxy silane, n-butyl amino propyl trimethoxy silane, t-butyl amino propyl trimethoxy silane, cyclohexyl amino propyl trimethoxy silane, dibutyl maleate amino propyl trimethoxy silane, dibutyl maleate substituted 4-amino 3,3-dimethyl butyl trimethoxy silane, amino propyl triethoxy silane and mixtures thereof, specific examples which include N-methyl-3-amino-2-methylpropyltrimethoxysilane, N-ethyl-3-amino-2-methylpropyltrimethoxysilane, N-ethyl-3-amino-2-methylpropyldiethoxysilane, N-ethyl-3-amino-2-methylpropyltriethoxysilane, N-ethyl-3-amino-2-methylpropylmethyldimethoxysilane, N-butyl-3-amino-2-methylpropyltrimethoxysilane, 3-(N-methyl-3-amino-1-methyl-1-ethoxy)propyltrimethoxysilane, N-ethyl4-amino-3,3-dimethylbutyldimethoxymethylsilane, N-ethyl-4-amino-3,3-dimethylbutyltrimethoxysilane, bis-(3-trimethoxysilyl-2-methylpropyl)amine, N-(3′-trimethoxysilylpropyl)-3-amino-2-methylpropyltrimethoxysilane, N,N-bis((3-triethoxysilyl)propyl)amine, N,N-bis((3-tripropoxysilyl)propyl)amine, N-(3-trimethoxysilyl)propyl-3-(N-(3-trimethoxysilyl)-propylamino)propionamide, N-(3-triethoxysilyl)propyl-3-(N-3-triethoxysilyl)-propyl-amino)propionamide, N-(3-trimethoxysilyl)propyl-3-(N-3-triethoxysilyl)-propylamino)propionamide, 3-trimethoxysilylpropyl 3-(N-(3-trimethoxysilyl)-propylamino)-2-methyl propionate, 3-triethoxysilylpropyl 3-(N-(3-triethoxysilyl)-propylamino)-2-methyl propionate, 3-trimethoxysilylpropyl 3-(N-(3-triethoxysilyl)-propylamino)-2-methyl propionate, and N,N′-bis((3-trimethoxysilyl)propyl)amine. Examples of suitable mercaptoalkoxysilanes include but are not limited to 3-mercaptopropyltrimethoxysilane, mercaptomethylmethyldiethoxysilane, 3-mercaptopropylmethyldimethoxysilane and 3-mercaptopropyltriethoxysilane.

Alpha-silanes are extremely reactive toward water and they also can be used in the invention as endcap precursors for accelerating hydrolysis reaction rates. Examples of useful alpha-silanes include, but are not limited to, N-trimethoxylsilylmethyl-O-methyl-carbamate, N-dimethoxy(methyl)silylmethyl-O-methyl-carbamate, N-cyclohexylaminomethylmethyldiethoxysilane, N-cyclohexylaminomethyltriethoxysilane, and N-Phenylaminomethyltrimethoxysilane.

In one embodiment of this invention, the hydrolysable silane moieties are selected from mono- di- or tri-alkoxysilanes, mono- di- or tri-alkenoxysilanes, mono- di- or tri-acetoxysilanes, mono- di- or tri-alketoximesilanes or mixtures thereof. Preferably, the hydrolysable silane function groups are selected from alkoxy, acyloxy, or mixtures thereof.

The hydrolysable-silane polymer is prepared by reacting an isocyanate-functional monomer, oligomer, or polymer with the hydrolysable silane moieties. Typically all or nearly all of the isocyanate functionality on the monomer, oligomer, or polymer is reacted with a silane. The degree of reaction can be checked by monitoring the residual isocyanate functionality by titration or by FTIR. To avoid the presence of free isocyanate, typically the amount of silane required to react with 100% of the isocyanates is calculated and then up to 2 to 10% by equivalent excess silane is added. Preferably 4 to 6% excess is added.

In another embodiment, the hydrolysable silane polymer is prepared by reacting a di or tri functional polyol with an (isocyanatoalkyl)dialkoxysilane, (isocyanatoalkyl)trialkoxysilane, or mixtures thereof. Examples of suitable isocyanate silanes include, but are not limited to, 3-isocyanatopropyl trimethoxysilane, and 3-isocyanatopropyl triethoxysilane. In order to ensure that the reaction goes to completion, typically a slight (1-10% equivalent excess) of polyol is employed.

### Molecular Sieves

Molecular sieves useful in the present invention are those that undergo hydration and dehydration with little or no change in their crystalline structure. It is preferred that the molecular sieves of the present invention contain less than 0.5% by weight water based on the weight of the completely water free molecular sieve. In other aspects the molecular sieves of the present invention contain less than 0.05% by weight water or 0% water. Dehydration of the molecular sieves can be completed using any method that results in the complete removal of water on the surface and in the pores of the molecular sieve. Once dehydrated, the sieves have a strong tendency to fill the cavity again and will accept almost any molecule capable of entering the cavity. In instances where more than one material is present the sieve will select the molecule that enters the pore based on electrostatic attractions. The molecular sieves may be in powder or crystalline form.

Several types of molecular sieves exist. These include, synthetic zeolites such as zeolite type A, zeolite type X and other zeolites, such as those described in U.S. Pat. No. 4,574,052; non-zeolite molecular sieves, such as those described in U.S. Pat. No. 5,520,796, including metalloaluminophosphates, silicoaluminophosphates, and faujasite; and natural molecular sieves including erionite, mordenite, analcite, pauling-ite, ptilolite, clinoptilolite, ferrierite, chabazite, genclinite, levynite, erionite. Since not all molecular sieves are available on the commercial scale, Zeolite A and Zeolite X are preferred. Additionally, powdered molecular sieves are preferred as a way to have a more evenly foaming product.

The basic formula for molecular sieves is aM_{2/n}O.bSiO₂.cAl₂O₃.dH₂O, where M is a metal cation, ordinarily K, Na or Ca but other cations may be substituted by exchange, n metal cation's valence, a is the number of moles of metal cation, b is the number of moles of silica, c is the number of moles of alumina and d is the number of moles of hydration contained within the pores. The crystalline structure of the molecular sieve is one which contains varying sizes of pores, depending on the metal cation used. The most common commercially available molecule sieve powders are 3A, 4A, 5A and 13X. Type 3A is the potassium form of the Type A crystal structure and has a pore size that allows molecules with a critical diameter of 3 Å, or less, to enter the pore. Type 4A is the sodium form of the Type A crystal structure has a pore size that allows molecules with a critical diameter of 4 Å, or less, to enter the pore. Type 5A is the calcium form of the Type A crystal structure has a pore size that allows molecules with a critical diameter of 5 Å, or less, to enter the pore. Type 13X is the sodium form of the Type X crystal structure has a pore size that allows molecules with a critical diameter of 10 Å, or less, to enter the pore.

Anhydrous molecular sieves are considered to be less than 0.5%, by weight water based on the weight of the completely water free molecular sieve. However, this invention combines molecular sieves and moisture curable polymers in a single component; as such for this invention it is beneficial to use molecular sieves with less than 0.05% by weight water based on the weight of the completely water free molecular sieve. Any means of removing all water from within the pores is suitable for use in this invention, but heating to temperatures greater than 200° C., for greater than a period of more than 3 hours is preferred. Once all moisture is removed the molecular sieve should be cooled under an atmosphere that is free of moisture. The atmosphere that the sieves are exposed to should consist of the gaseous blowing agent that will be stored within the molecular sieves. Suitable gases include dry air, N₂, CO₂, He, Ar, chlorofluorocarbons, hydrogenated chlorofluorocarbons, or any other gas that can enter the pore of the selected molecular sieve. If flammable gases are to be used, the molecular sieves should be cooled under vacuum and placed under a blanket of the gas when a safe temperature is reached. Once the molecular sieves have been dried and the blowing gas has been loaded, special care must be taken to ensure that no moisture is able to come into contact with the molecular sieves.

### Catalysts

Catalysts suitable for the invention are those capable of increasing the rate of reaction between the moisture sensitive groups of the polymer and atmospheric moisture. Examples include, but are not limited to, one or more of the following: organometallic compounds based on tin, titanium, platinum, zinc, zirconium, etc., bifunctional catalysts, boron trifluoride complexes and lewis acids.

Organotin catalysts in the invention, for example, dibutyltindilaurate; dibutyltindiacetate; dibutyltindimethoxide; carbomethoxyphenyl tin tris-uberate; tin octoate; isobutyl tin triceroate; dimethyl tin dibutyrate; dimethyl tin di-neodeconoate; triethyl tin tartrate; dibutyl tin dibenzoate; tin oleate; tin naphthenate; butyltintri-2-ethylhexoate; and tinbutyrate. The preferred catalysts are tin compounds, with dibutyltindilaurate and dibutyltindiacetate are particularly preferred.

Organic titanates perform a cross-linking function in nonaqueous condensation reaction of silanol groups. In according to the present invention, highly reactive alkoxide organic titanates may be utilized in the composition to improve the curing rate and the product properties. The suitable alkoxide organic titanates including: tetra-isopropyl titanate, tetra-n-butyl titanate, tetra-ethyl titanate, tetra aoctyl titanate, titanium di-n-butoxide (bis-2,4-pentanedionate), titanium trimethylsiloxide.

Organic zinc compounds have similar performace with organotin compounds for the condensation reaction of silanes with silanol groups. Tin salts are generally more reactive than zinc salts in the condensation reaction, but zinc salts can provide higher rates late in the reaction. A suitable zinc catalyst is zinc 2-ethyl hexanoate.

Bifunctional catalysts containing both an active proton and a base such as dichloroacetic acid, diethylhydroxylamine, trichloroacetic acid, acetic acid-triethylamine, etc. demonstrate a high reaction rate for the condensation reaction of silanols and alkoxysilanes.

Strong Lewis acids, such as BF₃-MEA complex, can also be used. BF₃-MEA, provides a much lower activation energy for the hydrolysis reactions than that of organic tin.

U.S. Pub. 2010/0004367 describes the use amidines compounds, guanidine compounds, pyrimidine compounds, imidazoline compounds, and biguanide compounds to cure silylated polyurethanes, without the use organic tin compounds, and is incorporated as a reference herein.

Suitable catalysts, for use with polysiloxanes, are those that increase the rate of reaction between moisture sensitive groups of the polysiloxane polymer and atmospheric moisture. Examples include, but are not limited to, one or more of the following: organometallic compounds based on tin, titanium, platinum, zinc, zirconium, etc., and Bronsted acids. Examples of suitable catalysts include dibutyltindilaurate, dibutyltindiacetate, dibutyltindioctooate, tetraisobutylorthotitanate, titanium acetylacetonate, acetoacetic ester titanate, methane sulphonic acid, dodecylbenzene sulphonic acid, tetraethyl zirconium, tin-2-ethylhexanoate, tetra-n-propyl titanate, stannous neodecanoate, zinc benzoate and divinyltetramethyldisiloxane platinum complex.

### Additives

To help control the cell size and structure of the foam, surfactant can be added. Surfactants modify the surface tension and control degree of expansion the growing cell can withstand before it collapses on itself. Suitable surfactants are typically, though not always, silicone surfactants which include, but are not limited to, Dabco DC5043, Dabco DC198Dabco DC5160, Dabco DC5164, Dabco DC5526, Dabco DC5900 and Dabco DC5950. The concentration surfactants can be added is from 0 to 7% by weight, preferably 0.3 to 4% by weight.

The role of fillers is to modify the uncured and cured properties of the composition. Fillers may be added to make a product more hydrophilic or hydrophobic, provide reinforcement, improve acoustical properties, increase flame resistance or for other uses. With a high degree of filler the wet density becomes high and the foam's expansion is increasingly restricted as the pressure needed to expand the more rigid composition is greater. Additionally the particle size of the filler used can increase the thixotropic index of the liquid composition. Fillers suitable for the invention include, but are not limited to, any one or more of the following: pigments, ground calcium carbonates, precipitated calcium carbonates, precipitated silica, hydrophobicized precipitated silica, fumed silica, hydrophobicized fumed silica, clays, talc, mica, carbon black, titanium dioxide, ferric oxide, aluminum oxide, other metal oxides, quartz, rubber particles and hollow microspheres. Filler can be added at a 0 to 80% by weight, preferably 10 to 60% by weight, based on total weight of the composition.

The addition of plasticizer can be done to reduce the viscosity of the liquid composition and increase the flexibility of the cured composition. In accordance with the invention the suitable plasticizers for the invention include, but are not limited to, any one or a combination of the following: phthalates, adipates, sebacates, azelates, trimellitates, glutarates, benzoates, alkyl alcohols, and phosphates. Plasticizer can be present at a concentration of 0 to 70% by weight, preferably 20 to 40% by weight, based on total weight of the composition.

Adhesion promoters can be added to increase the cross-linking content of the composition and to increase the bonds that are made to the surfaces. In accordance with the invention suitable adhesion promoters are typically, though not always, bi- and tri-functional silanes including, but not limited to, any one or a combination of the following: gamma-glycidoxypropyltrimethoxysilane, N(beta-aminoethyl) gamma-aminopropyltrimethoxy-silane, gamma-aminopropyltrimethoxy silane and gamma-aminopropyltriethoxysilane. The concentration of adhesion promoters can be 0 to 5% by weight, preferably 0.1 to 1% by weight, based on total weight of the composition.

Moisture scavengers can be added to help prevent the premature curing of the polymer or gas release from the molecular sieves. In accordance with the invention, suitable moisture scavengers are those that rapidly and irreversibly react with water to generate products that do not react with moisture curable polymer or molecule sieves. Examples include, but are not limited to vinyltris(2-methoxyethoxy)silane, vinyltrimethoxysilane, para-toluenesulfonyl isocyanate, and calcium hydride. The concentration of moisture scavengers can be 0 to 10% by weight, preferably 0 to 5% by weight, based on total weight of the composition.

Due to the strong affinity water has to molecular sieves, any moisture contamination that occurs during manufacturing or packaging will be removed by the molecular sieves. This helps reduce the risk of moisture reacting with other components in the product and allows for the inclusion of other moisture sensitive foamable additives. These foamable additives include compounds that will react with water to release a gas and further decrease the foam density of the product including calcium hydride and hydride silicones. Suitable types of hydride silicones include, but are not limited to, polymethylhydrosiloxanes (including, but not limited to, trimethylsilyl terminated polymethylhydrosiloxane and polydiethoxysiloxane) and organo-hydrosiloxane copolymers (including, but not limited to, methylhydro-dimethylsiloxane copolymer, methylhydro-methylcyanopropylsiloxane copolymer, methylhydro-methyloctylsiloxane and copolymer) with polymethylhydrosiloxanes being ideal because they have the highest degree of active hydrogen relative to their weight.

Other additives suitable for the invention may include, but are not limited to, one or more of the following: pigments, thixotropes, ultra violet light stabilizers, anti-oxidants, fungicides, anti-bacterial additives, or perfumes.

In one aspect the foam composition comprises 10 to 70% by weight of the silylated polyurethane polymer, 5 to 50% by weight molecular sieves, 20 to 40% by weight plasticizer, up to 5% by weight water scavenger, 10 to 60% by weight filler, up to 3% by weight catalyst, up to 0.1 to 1% adhesion promoter, and 0.3 to 4% by weight surfactant, all based on total weight of the composition

### EXAMPLES

The method to produce the invented foam ensures the final product is stable and maintains the desired properties. Since both the curing and the foaming reactions require the presence of water or other atmospheric gases, controlling their abundance, or lack thereof, during the manufacture of the foam is important. Through the use of water scavengers or other drying agents in the beginning of the process, water that may be present in plasticizers or fillers will be removed before it can react with reactive groups. Performing % H₂O checks, via Karl Fischer titrations or other methods, throughout the manufacturing process aids in the monitoring of water before reactive agents are added. Purging or vacuuming the foam may be useful techniques to control the composition of the air within packaged material and to help remove moisture to improve stability. A vacuum may be used to remove air bubbles, introduced via mixing, but typically some nucleation bubbles should remain in the foam. Adding a dry gas, ie N₂, CO₂, dry air, etc., to introduce nucleation bubbles and alter the specific gravity can also be utilized. Ideally the molecular sieves should be activated to remove any molecule that may react with the polymer.

The resin composition has excellent moisture curing and foaming properties while exhibiting excellent storage stability. The moisture curing reaction of the composition can be adjusted to a reproducible gelling time through the manipulation of catalysts and cross-linking additives. The foam properties—including open vs. closed cells, uniformity, cell size, foam density, foaming rate, etc.—are also adjustable to meet the applications demands. The stability of the foam composition has been monitored through the use of heat aging on an unreacted sample and the resin was found to be very stable with only a minimal viscosity increase.

Examples of how the composition could be used include, but are not limited to, use as an adhesive, sealant, elastomer, void filling material, sound deadening foam or a coating. The composition would be stored in an air tight, water free environment (ie cartridge, pail, drum, etc.) and spread/dispensed via a trowel, caulking gun, or another type of volume controlled application device.

The examples below are provided to help illustrate the diversity of the inventive process and are not given for any purpose of setting limitations or defining the scope of the invention.

### Example 1

A moisture curable polyurethane foam was prepared by methods known to those in the art, by combining 42.68% by weight polyurethane prepolymer (Lupranate 5020 from BASF), 7.53% by weight plasticizer (ditridecyl adipate), 1.02% by weight water scavenger (para-toluenesulfonyl isocyanate), 1.86% by weight surfactant (Air Products Dabco DC 198), 38.38% by weight filler (ground calcium carbonate), 8.43% by weight anhydrous 5A molecular sieve and 0.1% by weight catalyst (dibutyltin dilaurate). The resultant foam has a wet density of 1.3 g/mL and a cured density of 0.83 g/mL. The foam has a hardness of 30 Shore A, tensile strength of 39 psi, a 35% elongation and skins in 50 minutes.

### Example 2

A moisture curable silylated polyurethane foam was prepared by methods known to those in the art, by combining 25.28% by weight silylated polyurethane prepolymer (SPUR⁺ Y-15735 LM from GE), 16.86% by weight plasticizer (ditridecyl adipate), 0.78% by weight water scavenger (vinyltris(2-methoxyethoxy)silane), 1.56% by weight surfactant (Air Products Dabco DC 198), 46.21% by weight filler (ground calcium carbonate), 8.85% by weight anhydrous 5A molecular sieve, 0.21% by weight catalyst (dibutyltin dilaurate) and 0.26% by weight adhesion promoter (N(beta-aminoethyl) gamma-aminopropyltrimethoxy-silane). The resultant foam has a wet density of 1.3 g/mL and a cured density of 0.72 g/mL. The foam has a hardness of 11 Shore A, tensile strength of 54 psi, a 194% elongation and skins in 180 minutes. Heat age test found the viscosity of the wet foam to rise only 2.38% indicating a stable product.

### Example 3

A moisture curable silylated polyurethane foam was prepared by methods known to those in the art, by adding 25.28% by weight silylated polyurethane prepolymer (SPUR⁺ Y-15735 LM from GE), 16.86% by weight ditridecyl adipate, 0.78% by weight vinyltris(2-methoxyethoxy)silane, 1.56% by weight plasticizer (ditridecyl adipate), 46.21% by weight filler (ground calcium carbonate), 8.85% by weight anhydrous 13X molecular sieve, 0.21% by weight catalyst (dibutyltin dilaurate) and 0.26% by weight adhesion promoter (N(beta-aminoethyl) gamma-aminopropyltrimethoxy-silane). The resultant foam has a wet density of 1.3 g/mL and a cured density of 0.99 g/mL. The foam has a hardness of 18 Shore A, tensile strength of 77 psi, a 211% elongation and skins in 180 minutes.

### Example 4

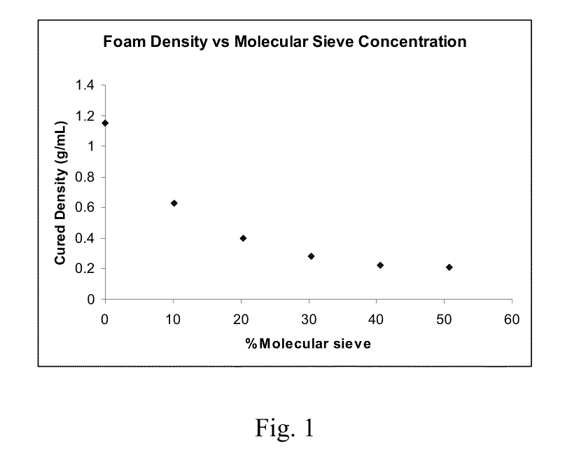

To demonstrate the foam density control that can be achieved for the one-component foams, a series of foams were prepared. The moisture curable foams were prepared by methods known to those in the art, and contained 27.91% by weight silylated polyurethane prepolymer (SPUR⁺ Y-15735 LM from GE), 18.61% by weight plasticizer (ditridecyl adipate), 0.80% by weight water scavenger (vinyltris(2-methoxyethoxy)silane), 1.72% by weight surfactant (Air Products Dabco DC 198), 0.23% by weight catalyst (dibutyltin dilaurate), and contained filler (ground calcium carbonate), and 5A anhydrous molecular sieves such that the total concentration of the ground calcium carbonate and 5A molecular sieve was 50.72% by weight. The resultant foams had a cured density of 1.15 g/mL to 0.21 g/mL. FIG. 1 displays the relationship between the cured foam density and the molecular sieve concentration, as a weight percentage of the entire foam, for the described foams.

### Example 5

A moisture curable silicone foam was prepared by methods known to those in the art, by adding 72.76% by hydroxy functional polydimethyl siloxane polymer, 5.39% methyltrimethoxysilane, 0.36% catalyst (titanium ethylacetoacetate), 11.23% filler (hydrophobic fumed silica) and 10.26% by weight anhydrous 5A molecular sieve. The resultant foam has a wet density of 1.0 g/mL and a cured density of 0.64 g/mL, with a hardness of 9 Shore A.

### Example 6

A moisture curable silylated polyurethane foam with a decreased foam density, due to the addition of calcium hydride, was prepared by methods known to those in the art. The foam was prepared by combining 25.21% by weight silylated polyurethane prepolymer (SPUR⁺ Y-15735 LM from GE), 16.81% by weight plasticizer (ditridecyl adipate), 0.78% by weight water scavenger (vinyltris(2-methoxyethoxy)silane), 1.56% by weight surfactant (Air Products Dabco DC 198), 46.08% by weight filler (ground calcium carbonate), 8.83% by weight anhydrous 5A molecular sieve, 0.21% by weight catalyst (dibutyltin dilaurate) and 0.26% by weight adhesion promoter (N(beta-aminoethyl) gamma-aminopropyltrimethoxy-silane) and 0.28% by weight calcium hydride. The resultant foam has a wet density of 1.3 g/mL and a cured density of 0.50 g/mL. The foam has a hardness of 8 Shore A, tensile strength of 25 psi, a 133% elongation and skins in 180 minutes.

What is claimed is:

1. A one-component moisture curable foam composition comprising (1) a moisture curable polymer and (2) anhydrous molecular sieves.

2. The foam composition according to claim 1 comprising 5 to 95% by weight of the moisture-curable polymer and 3 to 75% by weight of the molecular sieves, based on total weight of the composition.

3. The foam composition according to claim 1 comprising 10 to 70% by weight of the moisture-curable polymer and 5 to 50% by weight of the molecular sieves, based on total weight of the composition.

4. The foam composition according to claim 1 comprising a moisture curable polymer selected from the group consisting of silylated polyurethanes, alkoxysilane terminated polyether polymers, moisture curable silicones, and polyurethanes comprising excess isocyanate reacted with active hydrogen containing molecules.

5. The foam composition according to claim 4 comprising polyurethanes prepared from excess isocyanate reacted with one or more polyols.

6. The foam composition according to claim 1 further comprising up to 10% by weight based on total weight of the composition of one or more catalysts.

7. The foam composition of claim 1 further comprising one or more catalysts selected from the group consisting of organometallic compounds based on tin, titanium, platinum, zinc, and zirconium.

8. The foam composition according to claim 1 further comprising up to 90% by weight of at least one additive selected from the group consisting of fillers, plasticizers, solvents, surfactants, adhesion promoters, pigments, water scavengers, and foamable additives.

9. The foam composition according to claim 8 further comprising at least one foamable additive selected from the group consisting of calcium hydride and hydride silicone.

10. The foam composition according to claim 8 comprising at least one plasticizer selected from the group consisting of phthalates, adipates, sebacates, azelates, trimellitates, glutarates, benzoates, alkyl alcohols, and phosphates.

11. The foam composition according to claim 8 comprising at least one filler selected from the group consisting of pigments, calcium carbonate, silica, clays, talc, mica, carbon black, titanium dioxide, ferric oxide, aluminum oxide, other metal oxides, quartz, rubber particles and hollow microspheres.

12. The foam composition according to claim 8 comprising at least one adhesion promoter selected from the group consisting of bi- and tri-functional silanes.

13. The foam composition according to claim 8 comprising a silicone surfactant.

14. The foam composition according to claim 1 comprising molecular sieves containing 0 to 0.5% by weight water based on the weight of the completely water free molecular sieve.

15. The foam composition according to claim 1 comprising molecular sieves containing 0 to 0.05% by weight water based on the weight of the completely water free molecular sieve.

16. The foam composition according to claim 1 comprising molecular sieves containing 0% by weight water based on the weight of the completely water free molecular sieve.

17. The foam composition according to claim 1 comprising molecular sieves comprising zeolite type A, zeolite type X, or mixtures thereof.

18. The foam composition according to claim 1 comprising molecular sieves selected from the group consisting of metalloaluminophosphates, silicoaluminophosphates, and faujasite.

19. The foam composition according to claim 1 comprising molecular sieves selected from the group consisting of erionite, mordenite, analcite, pauling-ite, ptilolite, clinoptilolite, ferrierite, chabazite, genclinite, levynite, erionite.

20. The foam composition according to claim 1 wherein the molecular sieves are in a powder or crystalline form.

21. A one-component moisture curable foam composition comprising 10 to 70% by weight of a silylated polyurethane polymer, 5 to 50% by weight molecular sieves, 20 to 40% by weight plasticizer, up to 5% by weight water scavenger, 10 to 60% by weight filler, up to 3% by weight catalyst, up to 0.1 to 1% adhesion promoter, and 0.3 to 4% by weight surfactant, all based on total weight of the composition.

22. A one-component moisture curable polyurethane foam composition comprising (1) a moisture curable polymer; (2) anhydrous molecular sieves; (3) plasticizer; (4) water scavenger; (5) filler; (6) catalyst; (7) adhesion promoter; and (8) surfactant.
